(19) United States
(12) Patent Application Publication
(10) Pub. No.: US 2014/0164380 A1
(43) Pub. Date: Jun. 12, 2014

(54) METHOD AND APPARATUS FOR AGGREGATING, EXTRACTING AND PRESENTING REVIEW AND RATING DATA

(71) Applicants: DMITRIY PAVLOV, Redwood City, CA (US); Alex Tokarchuk, San Mateo, CA (US)

(72) Inventors: DMITRIY PAVLOV, Redwood City, CA (US); Alex Tokarchuk, San Mateo, CA (US)

(21) Appl. No.: 13/952,492

(22) Filed: Jul. 26, 2013

Related U.S. Application Data
(60) Provisional application No. 61/676,155, filed on Jul. 26, 2012.

(51) Int. Cl. G06F 17/30

(52) U.S. Cl. CPC G06F 17/30424; G06F 17/30598; G06F 17/30699
USPC 707/737; 707/769

(57) ABSTRACT

In an embodiment, a system is provided. The system includes a ratings database and a website database. A web crawler is provided to crawl review sites and rating sites of the web. The web crawler is further to access data from the web and store data from the web in a ratings database. The web crawler is also to identify links to other review sites and ratings sites of the data from the web, to store the links in a website database, and to identify sites to crawl from the website database. A data analyzer is provided to analyze data of the ratings database and to normalize data from the web within the ratings database on an essentially continuous basis. A data presenter is provided to receive queries from users and to query the ratings database based on queries from users. The data presenter is to present data to a user responsive to queries and to filter data presented to the user responsive to further user queries.

### CROSS-REFERENCE TO RELATED APPLICATIONS

This application claims priority to U.S. Provisional Patent Application No. 61/676,155, entitled “METHOD AND APPARATUS FOR AGGREGATING, EXTRACTING AND PRESENTING REVIEW AND RATING DATA” and filed on Jul. 26, 2012, which is incorporated herein by reference in its entirety.

### BACKGROUND

While the dawn of the Internet and the World Wide Web brought a great deal more information to users, it brought downsides as well. More opportunities exist to find information about products. More resellers, dealers, and other outlets now sell the same or similar products. More products of all kinds are directly available to consumers. The Internet has broken down some geographical barriers, but has thrown so much information at users that it becomes difficult to make sense of such information.

Search engines provide an option for finding relevant information. However, searching on a search engine leads to individual pieces of content. A user is left to decide what content is most useful personally, and what content is less useful for one reason or another.

Review websites can also be helpful. However, it is rare for review websites to capture much of the overall information available about a product. Moreover, review websites tend to have varying formats, coverage, and may specialize in unexpected ways that limit access to information about seemingly related products.

Shopping websites, such as amazon.com, for example, may provide some information about a product. However, such websites similarly suffer from limited information overall, and have wide variations based on user interest. Moreover, shopping websites tend to have a built-in motivation to sell a product to a user, rather than simply provide information.

Thus, it may be useful to provide a system which will allow a user to find information about products from a variety of sources. Moreover, it may be useful to provide such a system with filtering options for removal of some information by user choice. Also, it may be useful to provide such a system wherein information from diverse sources undergoes some degree of normalization for uniform presentation.

### SUMMARY

The following summary provides non-limiting examples of some embodiments, and does not restrict the invention.

In an embodiment, a system is provided. The system includes a ratings database and a website database. A web crawler is provided to crawl review sites and rating sites of the web. The web crawler is further to access data from the web and store data from the web in a ratings database. The web crawler is also to identify links to other review sites and ratings sites of the data from the web, to store the links in a website database, and to identify sites to crawl from the website database. A data analyzer is provided to analyze data of the ratings database and to normalize data from the web within the ratings database on an essentially continuous basis. A data presenter is provided to receive queries from users and to query the ratings database based on queries from users. The data presenter is to present data to a user responsive to queries and to filter data presented to the user responsive to further user queries.

In another embodiment, a method is provided. The method includes accessing a next website in a database of websites. The method also includes receiving data from the next website. The method further includes storing data from the next website in a ratings database, extracting links to other websites from the data from the next website, and storing the links to other websites in the database of websites. The method also includes advancing the next website of the database of websites within the database of websites to the website after the website just accessed. The method further includes repeating the accessing, receiving, storing data, extracting, storing the links and advancing.

In yet another embodiment, a method is provided. The method includes accessing a dataset in a ratings database. The method also includes determining if the dataset in the ratings database includes data retrieved after the dataset was last accessed. The method further includes extracting ratings data from the dataset, normalizing ratings data of the dataset, and storing the ratings data of the dataset with normalized ratings within the ratings database. Also, the method includes extracting review data from the dataset, normalizing review data of the dataset, and storing the review data of the dataset with normalized reviews within the ratings database. Moreover, the method includes identifying a dataset following the dataset just accessed. The method further includes advancing to the dataset following the dataset just accessed. The method also includes repeating the accessing, determining, extracting ratings data, normalizing ratings data, storing the ratings data, extracting review data, normalizing review data, storing the review data, identifying the dataset and advancing to the dataset.

In still another embodiment, a method is provided. The method includes receiving a user query from a user, with the user query including keywords. The method also includes querying a ratings database responsive to the user query, using the keywords of the user query. The method further includes receiving responsive data from the ratings database responsive to the querying. Also, the method includes organizing responsive data from the ratings database based on preferences of the user. Furthermore, the method includes presenting the responsive data from the ratings database to the user through a user interface. Moreover, the method includes receiving customization requests from the user. Additionally, the method includes filtering the responsive data from the ratings database responsive to the customization requests from the user. Also, the method includes presenting the responsive data from the ratings database as filtered to the user through the user interface.

In another embodiment, a system is provided. The system includes a website database embodying website URLs (universal resource locators) and data related to time of last access of the website URLS. The system also includes a ratings database embodying ratings data and review data from external websites found at website URLs. The ratings data and review data further includes data related to time of collection and time of processing of the ratings data and review data. The system includes a web crawler to crawl websites at website URLS of the website database. The web crawler is to retrieve data from websites at website URLs of the website database, and to store ratings data and review data from websites at website URLs of the website database in the ratings database. The system also includes a ratings data processor to review ratings data and review data in the ratings database after collection of the ratings data and review data and before processing of the ratings data and review data. The ratings data processor normalizes ratings within a predetermined numerical scale, and the ratings data processor normalizes review information for presentation to a user. The system further includes a presentation module. The presentation module interacts with a user and receive queries for information. The presentation module passes queries to the ratings database and receives ratings and review data from the ratings database responsive to the queries passed to the ratings database. The presentation module presents data from the ratings database to a user rearranges presentation of data from the ratings database responsive to feedback from a user.

In still another embodiment, a method is provided. The method includes accessing a next website in a database of websites. The method also includes receiving data from the next website. The method further includes storing data from the next website in a ratings database. The method also includes extracting links to other websites from the data from the next website and storing the links to other websites in the database of websites. The method further includes advancing the next website of the database of websites within the database of websites to the website after the website just accessed. Also, the method includes accessing a dataset in a ratings database. Further, the method includes determining if the dataset in the ratings database includes data retrieved after the dataset was last accessed. Moreover, the method includes extracting ratings data from the dataset, normalizing ratings data of the dataset and storing the ratings data of the dataset with normalized ratings within the ratings database. Additionally, the method includes extracting review data from the dataset, normalizing review data of the dataset and storing the review data of the dataset with normalized reviews within the ratings database. Furthermore, the method includes identifying a dataset following the dataset just accessed. The method also includes advancing to the dataset following the dataset just accessed. The method further includes receiving a user query from a user, the user query including keywords. The method additionally includes querying a ratings database responsive to the user query, using the keywords of the user query. The method also includes receiving responsive data from the ratings database responsive to the querying. The method further includes organizing responsive data from the ratings database based on preferences of the user. Moreover, the method includes presenting the responsive data from the ratings database to the user through a user interface. Additionally, the method includes receiving customization requests from the user. Furthermore, the method includes filtering the responsive data from the ratings database responsive to the customization requests from the user. Also, the method includes presenting the responsive data from the ratings database as filtered to the user through the user interface.

In an embodiment, a system is provided. The system includes a ratings database and a website database. The system also includes a web crawler coupled to the website database and the review database. The system further includes a data analyzer coupled to the website database and the review database. The system also includes a data presenter coupled to the ratings database and coupled to a user interface.

### BRIEF DESCRIPTION OF THE DRAWINGS

The present invention is illustrated by way of example in the accompanying drawings.

FIG. 1 illustrates an embodiment of a ratings and review aggregation system.

FIG. 2 illustrates an embodiment of a process of requesting websites.

FIG. 3 illustrates an embodiment of a process of searching for websites.

FIG. 4 illustrates an embodiment of a process of extracting data from review or rating websites.

FIG. 5 illustrates an embodiment of the process of presenting aggregated data to a user.

FIG. 6 illustrates an alternative embodiment of the ratings and review aggregation system.

FIG. 7 illustrates an embodiment of an Internet and network system.

FIG. 8 illustrates an embodiment of a computer or machine.

FIG. 9 illustrates an embodiment of a user interface which may be used in presenting data to a user and receiving requests.

FIG. 9A illustrates an embodiment of the user interface of FIG. 9 displaying categories for selection.

FIG. 10 illustrates an embodiment of a user interface which may be used to present data about a set of products to a user.

FIG. 10A illustrates an embodiment of the user interface of FIG. 10 which displays categories for selection.

FIG. 11 illustrates an embodiment of a user interface which may be used to present review and recommendation data about a specific product to a user.

FIG. 11A illustrates an embodiment of the user interface of FIG. 11, which may be used to present information about buying a product to a user.

FIG. 12 illustrates an embodiment of a system such as the system of FIG. 6 which incorporates access for advertising and selling.

FIG. 13 illustrates an alternative embodiment of the system of FIG. 12.

FIG. 14 illustrates an embodiment of the system of FIG. 12 which may be used to provide review and ratings information on third party websites.

The drawings should be understood as illustrative rather than limiting.

### DETAILED DESCRIPTION

In various embodiments, systems, apparatuses and methods are contemplated. Various embodiments contemplate provision of a system which will allow a user to find information about products from a variety of sources. Moreover, such embodiments may provide a system with filtering options for removal of some information by user choice. Such a system, in some embodiments, normalizes information from diverse sources for uniform presentation.

A system, method and apparatus is provided for aggregating, extracting and presenting review and rating data. The specific embodiments described in this document represent example instances of the present invention, and are illustrative in nature rather than restrictive.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments.

In many embodiments, systems and methods of aggregating reviews and ratings differ from existing systems and methods by aggregating all reviews and ratings and not assigning weights or editorial context or judgment to those reviews and/or ratings. In one embodiment, all reviews and ratings, rather, will get assigned to a specific “category” (e.g. “expert”, or “consumer”, or “other”). The rating system and method may then dynamically adjust and/or configure either an interface or underlying components based on the user's actions and/or selections. This allows for the user to see all of the actual raw data that would be available to them on the web, without having “editors” sensor or elevate the importance of a particular review and/or rating and without having an “arbitrary” “weight” assigned to any rating and/or review. This may, for example, allow users to see unfiltered results at their option, and thereby get a better sense of how similarly situated users react to a product (e.g. highly technical users are bored with a new product, or less technical users are frustrated with a new product).

As a further example, in one embodiment, if a user wishes to see all ratings for a given product, the user would leave all “options” selected for the rating and the system and interface would display an aggregated total representation of all available ratings for that particular product. If a user wishes to see only the “experts” ratings and/or reviews for a given product, they would either select the “expert” “option” or de-select the other “options” available (leaving the “expert” option selected) and the system and interface would display an aggregated representation of only the “expert” ratings and reviews.

Conversely, if a user wishes to see only the “consumer” (example) ratings and reviews, they would de-select the “expert” option and “other” options and the system would automatically display the aggregated representation of only the “consumer” ratings and reviews. If a user wishes to see any combination of the available “options”, they would select or de-select the appropriate “options” and the system would automatically display the selected aggregated representation of those corresponding ratings and reviews. The user can see all of the raw, un-altered data, and decide for themselves if they are interested in an “expert”, “consumer”, “other”, or any combination thereof, ratings and/or reviews. The ratings may be graphically represented by (but not limited to) a 5 star rating system; with one (1) star being the lowest “rating” and five (5) stars being the highest “rating”. Other similar rating systems may be used, on different scales and with different symbology or orientation of such a scale (e.g. a ‘1’ rating may be desired).

In one embodiment, the process begins with a custom crawler which searches the internet and pulls information from various different ratings/reviews sources. The crawler has A.I. (artificial intelligence) built into it to allow it to focus only on websites that provide ratings and reviews, and to update its list of sources automatically as new sites are located. The crawler parses out the reviews and ratings, subsequently populating a backend database with the parsed out information. Once the data is stored in the backend database, it can be easily retrieved and manipulated to be displayed for end users.

In particular, for some implementations, the Crawler populates the following database tables:
item—the item being reviewed/rated
item_rating_base—rating number and units collected from other websites (this table will contain the raw rating data for each item stored in our database (e.g. 4 out of 5 stars)).
item_review—collected end-user reviews
item_rating_update_queue—candidates for rating re-calculation. When the crawler finds new ratings for a given item, those ratings will get stored in this table pending a re-calculation of the overall default item rate.

The crawler uses time stamps to ensure that it pulls only the most recent review/rating data, instead of data that has already been collected. The crawler parses the reviews/ratings and determines which one is which, and then populates specific item review/rating database tables based on the data type. Additional database tables are also populated to ensure that an item is rated or re-rated based on newly gathered information.

With data available, ratings are then calculated, typically using the following fields in some implementations.
item_rating_base—rating number and unit collected from other websites (e.g. how many stars out of 5)
item_review—end-user reviews collected from other websites
item_rating_update_queue—candidates for calculating or re-calculating rate
item_rate—pointer to item table, contains pre-calculated proprietary rates and counts for rates and reviews.

Once the crawler enters new data, that it has collected for the item, into the item_rating_base and/or item_review tables, it inserts the item id into the item_rating_update_queue table. A continuously running agent checks item_rating_update_queue table for the candidates to calculate or re-calculate. The agent finds the first available item id with an empty time_calculation_started value, sets the time_calculation_started value to the current time and initiates a thread for calculating or re-calculating the item rating by passing the item id it needs to calculate or re-calculate into a new thread. The thread finds all records in the item_rating_base table for the item it needs to process, calculates/re-calculates the item rate, and updates item_rate table with new rates and review counts from the item_review table for the requested item. Rating counts are also updated in the same process. When the thread is finished, it deletes the entry in the item_rating_update_queue for the item it was processing.

Once the data is appropriately parsed, calculated and stored in the database, it can be retrieved and displayed for the end users.

Such display may involve, for example:
item—the item with ratings or reviews
item_category—item category (“book”, “car”)
item_subcategory—item subcategory (“calendar”, “Toyota”)
item_rate—pointer to item table, contains pre-calculated proprietary rates and counts for rates and reviews.
item_review—reviews for items.

In one embodiment, the user selects category/subcategory from a pre-populated list or types in text into search box and clicks ‘find’. The application then searches and locates the corresponding values in the item/category/subcategory tables in the database. Identified items are displayed as a list of links to the items in our database with corresponding descriptions and photographs. The user then clicks on desired item link. The item is displayed with default rate (our overall calculated rate) and most recent review. The user can select expert, other, consumer rates only or combination of any of them if desired, at which point the item is re-displayed with selected ratings. The user can also choose to see more reviews. Preferably, only the latest review is shown by default.

Many different embodiments are presented herein. For example, in an embodiment, a system is provided. The system includes a ratings database and a website database. A web crawler is provided to crawl review sites and rating sites of the web. The web crawler is further to access data from the web and store data from the web in a ratings database. The web crawler is also to identify links to other review sites and ratings sites of the data from the web, to store the links in a website database, and to identify sites to crawl from the website database. A data analyzer is provided to analyze data of the ratings database and to normalize data from the web within the ratings database on an essentially continuous basis. A data presenter is provided to receive queries from users and to query the ratings database based on queries from users. The data presenter is to present data to a user responsive to queries and to filter data presented to the user responsive to further user queries.

In another embodiment, a method is provided. The method includes accessing a next website in a database of websites. The method also includes receiving data from the next website. The method further includes storing data from the next website in a ratings database, extracting links to other websites from the data from the next website, and storing the links to other websites in the database of websites. The method also includes advancing the next website of the database of websites within the database of websites to the website after the website just accessed. The method further includes repeating the accessing, receiving, storing data, extracting, storing the links and advancing.

In yet another embodiment, a method is provided. The method includes accessing a dataset in a ratings database. The method also includes determining if the dataset in the ratings database includes data retrieved after the dataset was last accessed. The method further includes extracting ratings data from the dataset, normalizing ratings data of the dataset, and storing the ratings data of the dataset with normalized ratings within the ratings database. Also, the method includes extracting review data from the dataset, normalizing review data of the dataset, and storing the review data of the dataset with normalized reviews within the ratings database. Moreover, the method includes identifying a dataset following the dataset just accessed. The method further includes advancing to the dataset following the dataset just accessed. The method also includes repeating the accessing, determining, extracting ratings data, normalizing ratings data, storing the ratings data, extracting review data, normalizing review data, storing the review data, identifying the dataset and advancing to the dataset.

In still another embodiment, a method is provided. The method includes receiving a user query from a user, with the user query including keywords. The method also includes querying a ratings database responsive to the user query, using the keywords of the user query. The method further includes receiving responsive data from the ratings database responsive to the querying. Also, the method includes organizing responsive data from the ratings database based on preferences of the user. Furthermore, the method includes presenting the responsive data from the ratings database to the user through a user interface. Moreover, the method includes receiving customization requests from the user. Additionally, the method includes filtering the responsive data from the ratings database responsive to the customization requests from the user. Also, the method includes presenting the responsive data from the ratings database as filtered to the user through the user interface.

In another embodiment, a system is provided. The system includes a website database embodying website URLs (universal resource locators) and data related to time of last access of the website URLS. The system also includes a ratings database embodying ratings data and review data from external websites found at website URLs. The ratings data and review data further includes data related to time of collection and time of processing of the ratings data and review data. The system includes a web crawler to crawl websites at website URLS of the website database. The web crawler is to retrieve data from websites at website URLs of the website database, and to store ratings data and review data from websites at website URLs of the website database in the ratings database. The system also includes a ratings data processor to review ratings data and review data in the ratings database after collection of the ratings data and review data and before processing of the ratings data and review data. The ratings data processor normalizes ratings within a predetermined numerical scale, and the ratings data processor normalizes review information for presentation to a user. The system further includes a presentation module. The presentation module interacts with a user and receive queries for information. The presentation module passes queries to the ratings database and receives ratings and review data from the ratings database responsive to the queries passed to the ratings database. The presentation module presents data from the ratings database to a user rearranges presentation of data from the ratings database responsive to feedback from a user.

In still another embodiment, a method is provided. The method includes accessing a next website in a database of websites. The method also includes receiving data from the next website. The method further includes storing data from the next website in a ratings database. The method also includes extracting links to other websites from the data from the next website and storing the links to other websites in the database of websites. The method further includes advancing the next website of the database of websites within the database of websites to the website after the website just accessed. Also, the method includes accessing a dataset in a ratings database. Further, the method includes determining if the dataset in the ratings database includes data retrieved after the dataset was last accessed. Moreover, the method includes extracting ratings data from the dataset, normalizing ratings data of the dataset and storing the ratings data of the dataset with normalized ratings within the ratings database. Additionally, the method includes extracting review data from the dataset, normalizing review data of the dataset and storing the review data of the dataset with normalized reviews within the ratings database. Furthermore, the method includes identifying a dataset following the dataset just accessed. The method also includes advancing to the dataset following the dataset just accessed. The method further includes receiving a user query from a user, the user query including keywords. The method additionally includes querying a ratings database responsive to the user query, using the keywords of the user query. The method also includes receiving responsive data from the ratings database responsive to the querying. The method further includes organizing responsive data from the ratings database based on preferences of the user. Moreover, the method includes presenting the responsive data from the ratings database to the user through a user interface. Additionally, the method includes receiving customization requests from the user. Furthermore, the method includes filtering the responsive data from the ratings database responsive to the customization requests from the user. Also, the method includes presenting the responsive data from the ratings database as filtered to the user through the user interface.

In an embodiment, a system is provided. The system includes a ratings database and a website database. The system also includes a web crawler coupled to the website database and the review database. The system further includes a data analyzer coupled to the website database and the review database. The system also includes a data presenter coupled to the ratings database and coupled to a user interface.

Review of the figures and accompanying text may further illustrate some of these processes.

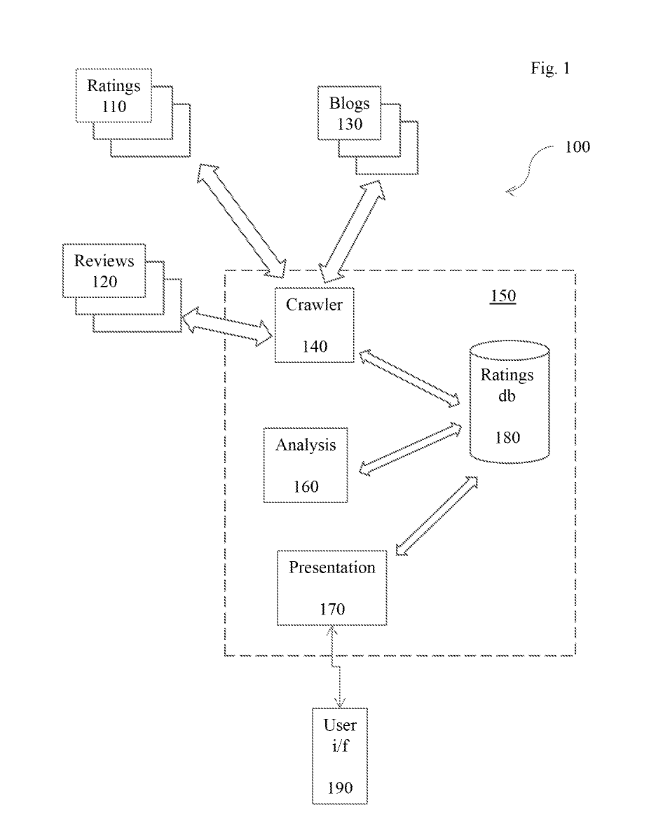

FIG. 1 illustrates an embodiment of a ratings and review aggregation system. System 100 may be used to aggregate reviews ratings and other commentary about consumer goods. Such aggregation may allow for presentation of a more coherent analysis of ratings from a variety of sources. Using ratings from a variety of sources that user may expect a more balanced and overall accurate picture of what the Internet community thinks of a product.

System 100 includes data sources such as ratings 110, reviews 120 and blogs 130. These data sources are found in processed by a crawler 140 which requests data from external websites, and seeks out links on such external websites to find additional websites. Aggregation system 150 includes the crawler 140, an analysis engine 160, presentation engine 170 and a ratings database 180. Crawler 140 insert raw data into ratings database 180. Analysis engine 160 analyzes the raw data retrieved by crawler 140 and processes it, refining and normalizing the data in database 180. Presentation engine 170 accesses data from database 180 based on requests from a user utilizing user interface 190. Presentation engine 170 may filter data based on requests from the user of user interface 190 for example. Thus, a user utilizing user interface 190, may review data from a variety of different ratings, reviews and blog websites, using normalized data and getting an overall picture of reaction to a product.

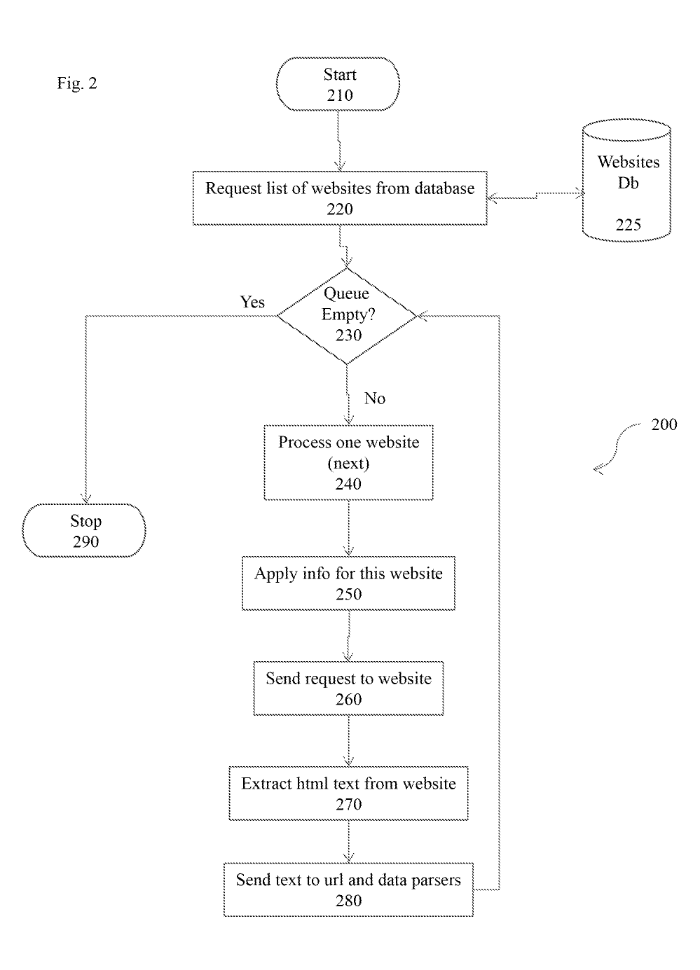

FIG. 2 illustrates an embodiment of a process of requesting websites. Process 200 includes requesting a list of websites from a database, determining that websites are available, processing a next website in the list, applying information for the website based on various criteria, sending a request to the website for data, extracting web data (e.g. html text) from the website, and sending text to parser modules. Process 200 thus represents an initial pass at finding a website and extracting data from it.

Process 200 and other processes referred to in this document are described as a set of modules, which may be executed or implemented in a variety of ways, whether by a pre-programmed machine, a specialized machine, or a set of machines, and which may be re-arranged in order and in serial or parallel fashion within the context of the description. Process 200 initiates at module 210, and then requests at module 220 a list of websites from a website database 225. At module 230, a determination is made as to whether the list is empty. If so, the process ends at module.

If the list contains another website, the next website on the list is processed at module 240. At module 250, information is applied for the website, determining how much weight to give website data based on where it is found in the web. At module 260, a request is sent to the website, and at module 270, text (and other relevant data) is extracted from the data responsive to the request of module 260. At module 280, the text is sent to parser modules for matching with the ratings database 490 or a similar database.

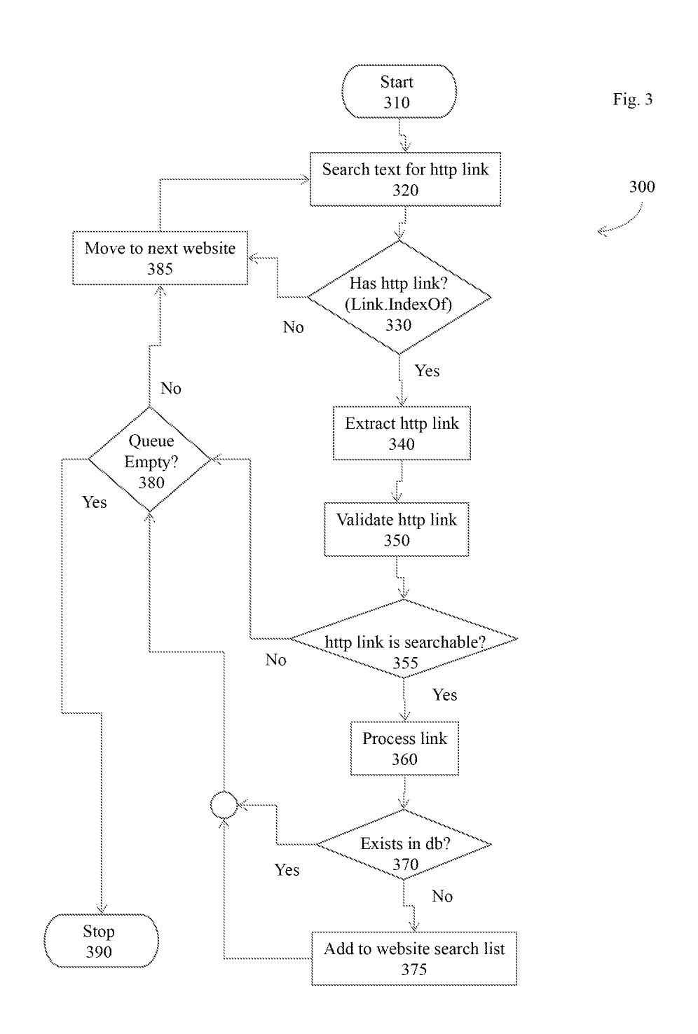

FIG. 3 illustrates an embodiment of a process of searching for websites. Process 300 includes searching text for an http link, extracting the http link, determining it is searchable, processing the link, determining the link has not already been searched, and adding the link to a search list or database. Process 300 thus provides a process of crawling links for purposes of finding additional information about reviews, ratings and the like.

Process 300 initiates at module 310 and includes searching text of a website at module 320 for an http link. At module 330, a determination is made as to whether such a link is present. If not, the process moves to a next site on a list of sites to check at module 385 (or it may move to module 380 to check whether the queue is empty).

If a link (or links) exists, then at module 340 the present http link is extracted and at module 350, the link is validated. At module 355, a determination is made as to whether the link is searchable (e.g. has useful data) or is not searchable (e.g. returns a 403 error). If the link is not searchable, the process determines if there are remaining links to check at module 380.

If the link is searchable, at module 360, the link is processed, and may be provided to process 200 of FIG. 2, for example. Moreover, a determination is made at module 370 as to whether the link currently exists in the database of websites (e.g. database 225 of FIG. 2, for example). If the link does not exist in the database of websites, the link is added to a website search list at module 375, such as by adding the link to a website search list used by process 200, for example.

The process eventually checks whether the list of websites to be checked is empty at module 380. If so, the process terminates at module 390. If not, the process moves to the next site at module 385. The process 300 then proceeds to module 320 and searches text for another http link.

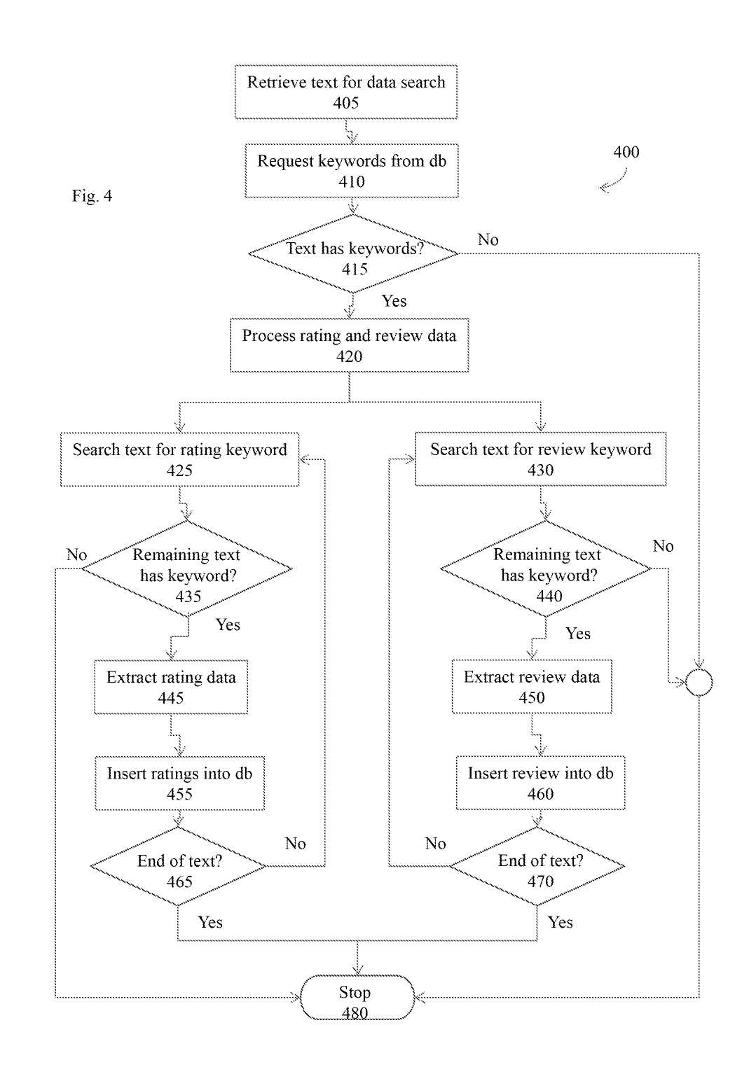

FIG. 4 illustrates an embodiment of a process of extracting data from review or rating websites. Process 400 includes retrieving text for data search, requesting keywords from a database, finding associated data from the database, and processing rating and review data from the database. For either rating or review data, the process includes searching text for a keyword, determining if the remaining text has the keyword, extracting relevant data (review or rating data), inserting the relevant data into the database, and searching the remainder of the rating or review data. Thus, process 400 includes analyzing text of ratings or reviews for relevant keywords, and processing the text for insertion into the ratings database, such as by normalizing ratings (e.g. 3/5 becomes 6.0/10.0, for example), and the inserting that data into the database.

Process 400 initiates with retrieval of text for data search at module 405. Keywords for data search are requested from a ratings database 490 at module 410, and a determination is made as to whether the keywords exist in the text at module 415. Rating and review data is then processed at module 420, using one of two processes based on the type of data involved.

Rating data is searched for rating keywords at module 425, and a determination is made at module 435 as to whether the text has a keyword. If not, the data is processed and the process ends at module 480. If the keyword is present, the rating data is extracted at module 445, and the extracted data is inserted into the ratings database at module 455. A determination is made at module 465 as to whether more text remains to be processed. If so, the process moves to module 425, and if not, the process ends at module 480.

Similarly, review data is searched for review keywords at module 430, and a determination is made at module 440 as to whether the text has a keyword. If not, the data is processed and the process ends at module 480. If the keyword is present, the review data is extracted at module 450, and the extracted data is inserted into the ratings database at module 460. A determination is made at module 470 as to whether more text remains to be processed. If so, the process moves to module 430, and if not, the process ends at module 480.

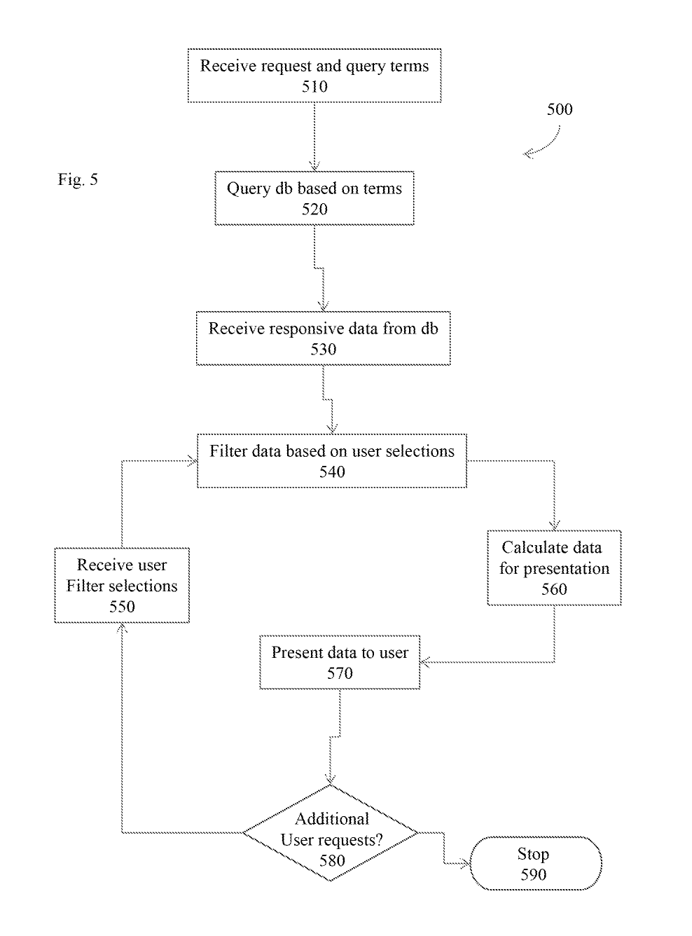

FIG. 5 illustrates an embodiment of the process of presenting aggregated data to a user. Process 500 includes receiving a request and associated query terms, querying a ratings database, receiving a response from the database, filtering data based on user selections which are received from the user, calculating data for presentation and presenting the data to the user. Thus, a user may request information about a product, refine that request based on filtering or additional or different search terms, and either stop or issue further requests.

Process 500 initiates with receipt of a request from a user at module 510. At module 520, the database is queried based on the request and associated search terms. At module 530, responsive data arrives form a ratings database in response to the query of module 520. At module 550, filter selections arrive from the user. As a result, at module 540, data is filtered based on such user selections. At module 560, remaining data after filtering is calculated (e.g. aggregated) for presentation. This data is then presented to the user at module 570. At module 580, a determination is made as to whether additional user requests are forthcoming. If so, the process moves to the relevant module (e.g. 510 or 550) and commences, or the process terminates at module 590.

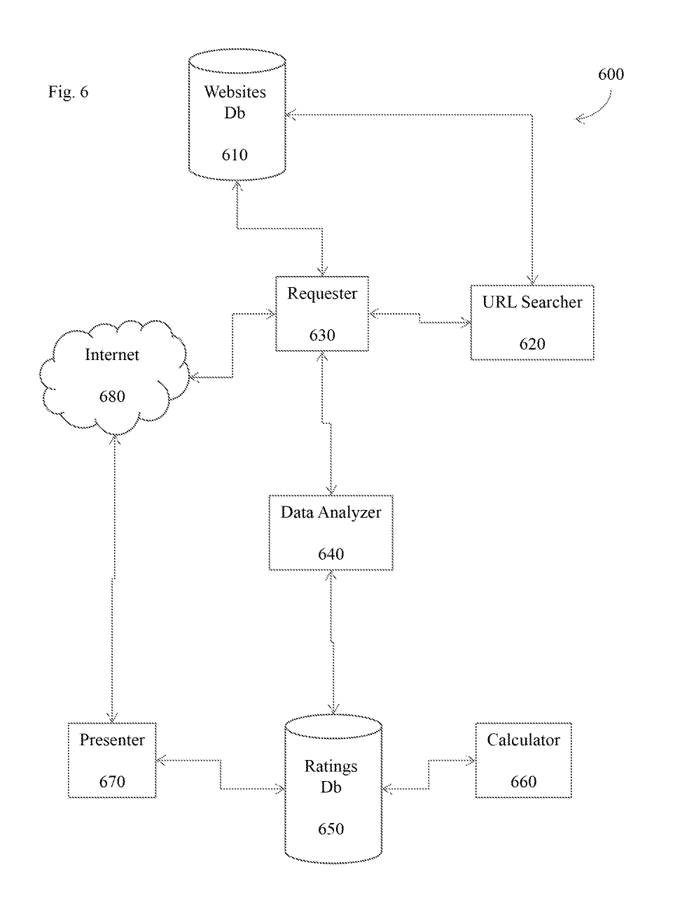

FIG. 6 illustrates another embodiment of the ratings and review aggregation system. System 600 includes a websites database, url searcher, requester, data analyzer, ratings database, calculator, presenter, and access to the Internet. Requester 630 accesses websites database 610 to find websites to access on Internet 680. Requester 630 requests html or similar website content and obtains such content from websites listed in website database 610. URL searcher 620 searches data from requester 630 to find additional websites to check, and places these websites in database 610.

Data analyzer 640 analyzes content from requester 630 and determines what ratings and review information is available from such content. This data is then normalized and placed in the ratings and review database 650. Calculator 660 periodically reviews data in database 650 and calculates overall values (e.g. min, max, average ratings, etc. for a given product), taking into account newly entered data. Calculator 660 reintroduces these calculated values into database 650, associated with related products and services.

Presenter 670 then interacts with a user to present information from database 650 to a user. Presenter 670 receives requests from a user through Internet 680. Such requests translate into queries to database 650, which responds with data about products involved in the queries. Presenter 670 formats data from database 650 responses into user-friendly formats. Moreover, responsive to user requests, presenter 670 further formats and recalculates data to filter out data as requested by a user.

Another view of the overall system and its various components in some embodiments may be beneficial. In one embodiment, the web crawler is a web spider program that can retrieve information, reviews, and ratings about products from any web site. The crawler then processes and saves extracted data in the rate database.

The uniqueness of the web crawler application and related system lies in its ability to extract reviews and rating data in different formats for any product, convert it into one standard format, and represent that data to customers on a consumer-accessible website.

In one embodiment, the web crawler processes web site URLs in the queue. This may implement a process similar to that of FIGS. 2-4 above, for example.

1) Requester retrieves a list of web sites to search from the Web Sites Database and places it in the queue. If queue is not empty, the requester goes to the first web site in the queue and processes it.

2) Requester visits a web site and extracts the HTML text of this web site.

3) Requester sends this data to the URL Searcher and Data Analyzer processes simultaneously

4) Once a Requester is done crawling a particular URL it removes it from the front of the queue.

5) When queue is empty, the process starts over at step 1.

6) URL Searcher parses HTML text and determines if it contains HTML links to other web pages. If yes, it extracts it and puts these URLs at the end of a queue.

7) URL Searcher also verifies if the webpage address exists in Web Site Database already, if it doesn't, it gets added to the DB.

8) Data Analyzer requests a list of Rating and Review keywords from the database.

9) Date Analyzer initiates two parallel search processes, one for Rate keywords and another for Reviews.

10) Data Analyzer parses the search results based on certain keywords. The data is then inserted into the database.

11) If no keywords are found in the results, process terminates.

12) Presenter retrieves formatted rate and review data from the database and presents it on the consumer-accessible website.

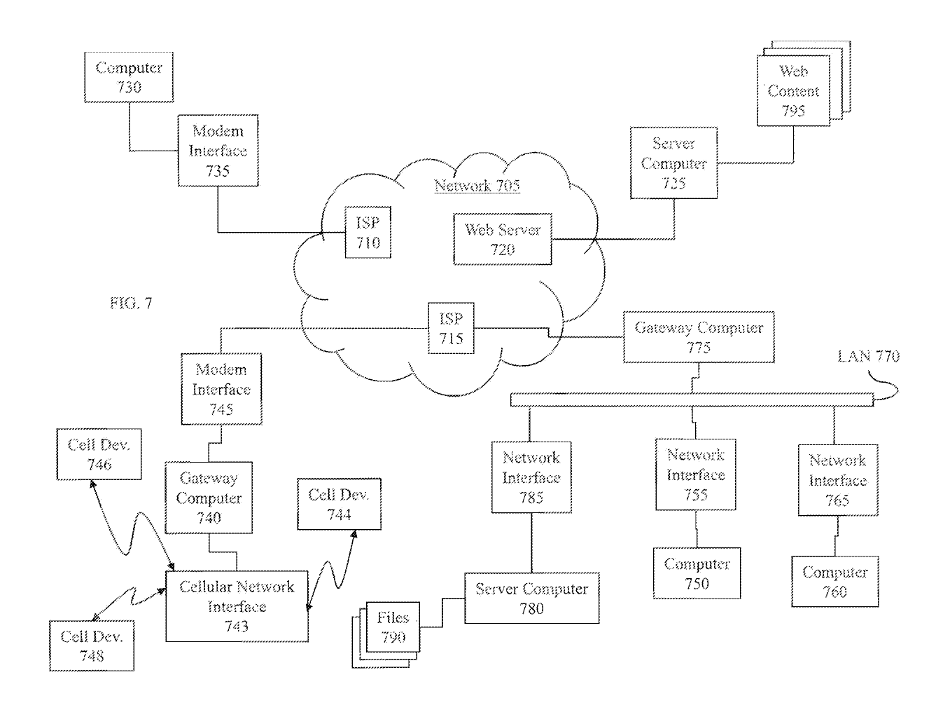

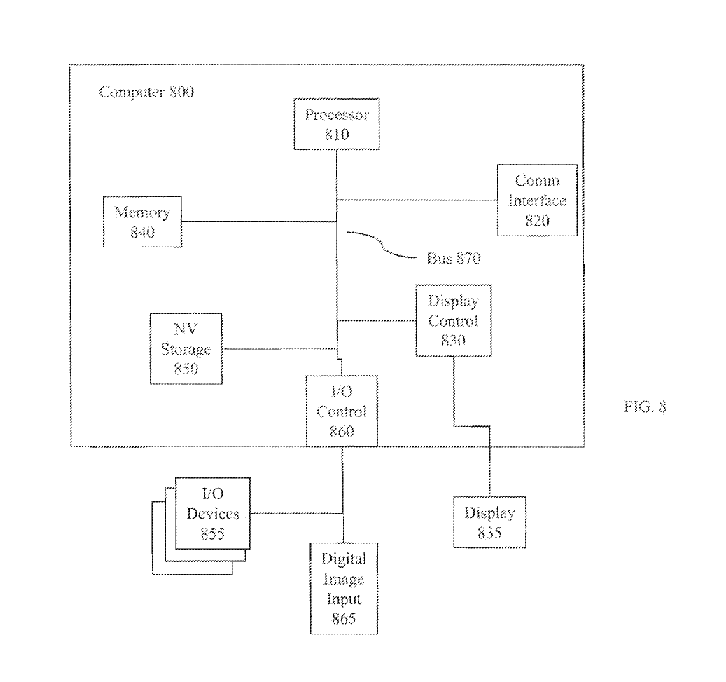

These various systems operate in conjunction with access to computers or machines and to the Internet and World Wide Web. FIG. 7 illustrates an embodiment of an Internet and network system. FIG. 8 illustrates an embodiment of a computer or machine. The following description of FIGS. 7-8 is intended to provide an overview of device hardware and other operating components suitable for performing the methods of the invention described above and hereafter, but is not intended to limit the applicable environments. Similarly, the hardware and other operating components may be suitable as part of the apparatuses described above. The invention can be practiced with other system configurations, including personal computers, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network.

FIG. 7 shows several computer systems that are coupled together through a network 705, such as the internet, along with a cellular or other wireless network and related cellular or other wireless devices. The term “internet” as used herein refers to a network of networks which uses certain protocols, such as the TCP/IP protocol, and possibly other protocols such as the hypertext transfer protocol (HTTP) for hypertext markup language (HTML) documents that make up the world wide web (web). The physical connections of the internet and the protocols and communication procedures of the internet are well known to those of skill in the art.

Access to the internet 705 is typically provided by internet service providers (ISP), such as the ISPs 710 and 715. Users on client systems, such as client computer systems 730, 750, and 760 obtain access to the internet through the internet service providers, such as ISPs 710 and 715. Access to the internet allows users of the client computer systems to exchange information, receive and send e-mails, and view documents, such as documents which have been prepared in the HTML format. These documents are often provided by web servers, such as web server 720 which is considered to be “on” the internet. Often these web servers are provided by the ISPs, such as ISP 710, although a computer system can be set up and connected to the internet without that system also being an ISP.

The web server 720 is typically at least one computer system which operates as a server computer system and is configured to operate with the protocols of the world wide web and is coupled to the internet. Optionally, the web server 720 can be part of an ISP which provides access to the internet for client systems. The web server 720 is shown coupled to the server computer system 725 which itself is coupled to web content 795, which can be considered a form of a media database. While two computer systems 720 and 725 are shown in FIG. 7, the web server system 720 and the server computer system 725 can be one computer system having different software components providing the web server functionality and the server functionality provided by the server computer system 725 which will be described further below.

Cellular network interface 743 provides an interface between a cellular network and corresponding cellular devices 744, 746 and 748 on one side, and network 705 on the other side. Thus cellular devices 744, 746 and 748, which may be personal devices including cellular telephones, two-way pagers, personal digital assistants or other similar devices, may connect with network 705 and exchange information such as email, content, or HTTP-formatted data, for example.

Cellular network interface 743 is representative of wireless networking in general. In various embodiments, such an interface may also be implemented as a wireless interface such as a Bluetooth interface, IEEE 802.11 interface, or some other form of wireless network. Similarly, devices such as devices 744, 746 and 748 may be implemented to communicate via the Bluetooth or 802.11 protocols, for example. Other dedicated wireless networks may also be implemented in a similar fashion.

Cellular network interface 743 is coupled to computer 740, which communicates with network 705 through modem interface 745. Computer 740 may be a personal computer, server computer or the like, and serves as a gateway. Thus, computer 740 may be similar to client computers 750 and 760 or to gateway computer 775, for example. Software or content may then be uploaded or downloaded through the connection provided by interface 743, computer 740 and modem 745.

Client computer systems 730, 750, and 760 can each, with the appropriate web browsing software, view HTML pages provided by the web server 720. The ISP 710 provides internet connectivity to the client computer system 730 through the modem interface 735 which can be considered part of the client computer system 730. The client computer system can be a personal computer system, a network computer, a web tv system, or other such computer system.

Similarly, the ISP 715 provides internet connectivity for client systems 750 and 760, although as shown in FIG. 7, the connections are not the same as for more directly connected computer systems. Client computer systems 750 and 760 are part of a LAN coupled through a gateway computer 775. While FIG. 7 shows the interfaces 735 and 745 as generically as a “modem,” each of these interfaces can be an analog modem, isdn modem, cable modem, satellite transmission interface (e.g. “direct PC”), or other interfaces for coupling a computer system to other computer systems.

Client computer systems 750 and 760 are coupled to a LAN 770 through network interfaces 755 and 765, which can be ethernet network or other network interfaces. The LAN 770 is also coupled to a gateway computer system 775 which can provide firewall and other internet related services for the local area network. This gateway computer system 775 is coupled to the ISP 715 to provide internet connectivity to the client computer systems 750 and 760. The gateway computer system 775 can be a conventional server computer system. Also, the web server system 720 can be a conventional server computer system.

Alternatively, a server computer system 780 can be directly coupled to the LAN 770 through a network interface 785 to provide files 790 and other services to the clients 750, 760, without the need to connect to the internet through the gateway system 775.

FIG. 8 shows one example of a personal device that can be used as a cellular telephone (744, 746 or 748) or similar personal device, or may be used as a more conventional personal computer, as an embedded processor or local console, or as a PDA, for example. Such a device can be used to perform many functions depending on implementation, such as game playing, office software functions, internet access and communication functions, monitoring functions, user interface functions, telephone communications, two-way pager communications, personal organizing, or similar functions. The system 800 of FIG. 8 may also be used to implement other devices such as a personal computer, network computer, or other similar systems.

The computer system 800 interfaces to external systems through the communications interface 820. In a cellular telephone, this interface is typically a radio interface for communication with a cellular network, and may also include some form of cabled interface for use with an immediately available personal computer. In a two-way pager, the communications interface 820 is typically a radio interface for communication with a data transmission network, but may similarly include a cabled or cradled interface as well. In a personal digital assistant, communications interface 820 typically includes a cradled or cabled interface, and may also include some form of radio interface such as a Bluetooth or 802.11 interface, or a cellular radio interface for example. Conventional computer systems often use an Ethernet connection to a network or a modem connection to the Internet, for example.

The computer system 800 includes a processor 810, which can be a conventional microprocessor such as an Intel pentium microprocessor or Motorola power PC microprocessor, a Texas Instruments digital signal processor, or some combination of the various types or processors. Note that processor 810 and the other components can represent single or multiple components of the same type. Memory 840 is coupled to the processor 810 by a bus 870. Memory 840 can be dynamic random access memory (dram) and can also include static ram (sram), or may include FLASH EEPROM, too. The bus 870 couples the processor 810 to the memory 840, also to non-volatile storage 850, to display controller 830, and to the input/output (I/O) controller 860. Note that the display controller 830 and I/O controller 860 may be integrated together, and the display may also provide input.

The display controller 830 controls in the conventional manner a display on a display device 835 which typically is a liquid crystal display (LCD) or similar flat-panel, small form factor display. The input/output devices 855 can include a keyboard, or stylus and touch-screen, and may sometimes be extended to include disk drives, printers, a scanner, and other input and output devices, including a mouse or other pointing device. The display controller 830 and the I/O controller 860 can be implemented with conventional well known technology. A digital image input device 865 can be a digital camera which is coupled to an I/O controller 860 in order to allow images from the digital camera to be input into the device 800.

The non-volatile storage 850 is often a FLASH memory or read-only memory, or some combination of the two. A magnetic hard disk, an optical disk, or another form of storage for large amounts of data may also be used in some embodiments, though the form factors for such devices typically preclude installation as a permanent component of the device 800. Rather, a mass storage device on another computer is typically used in conjunction with the more limited storage of the device 800. Some of this data is often written, by a direct memory access process, into memory 840 during execution of software in the device 800. One of skill in the art will immediately recognize that the terms “machine-readable medium” or “computer-readable medium” includes any type of storage device that is accessible by the processor 810 and also encompasses a carrier wave that encodes a data signal.

The device 800 is one example of many possible devices which have different architectures. For example, devices based on an Intel microprocessor often have multiple buses, one of which can be an input/output (I/O) bus for the peripherals and one that directly connects the processor 810 and the memory 840 (often referred to as a memory bus). The buses are connected together through bridge components that perform any necessary translation due to differing bus protocols.

In addition, the device 800 is controlled by operating system software which includes a file management system, such as a disk operating system, which is part of the operating system software. One example of an operating system software with its associated file management system software is the family of operating systems known as Windows CE® and Windows® from Microsoft Corporation of Redmond, Wash., and their associated file management systems. Another example of an operating system software with its associated file management system software is the Palm® operating system and its associated file management system. The file management system is typically stored in the non-volatile storage 850 and causes the processor 810 to execute the various acts required by the operating system to input and output data and to store data in memory, including storing files on the non-volatile storage 850. Other operating systems may be provided by makers of devices, and those operating systems typically will have device-specific features which are not part of similar operating systems on similar devices. Similarly, WinCE® or Palm® operating systems may be adapted to specific devices for specific device capabilities.

Device 800 may be integrated onto a single chip or set of chips in some embodiments, and typically is fitted into a small form factor for use as a personal device. Thus, it is not uncommon for a processor, bus, onboard memory, and display/I-O controllers to all be integrated onto a single chip. Alternatively, functions may be split into several chips with point-to-point interconnection, causing the bus to be logically apparent but not physically obvious from inspection of either the actual device or related schematics.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the various descriptions. In addition, the present invention is not described with reference to any particular programming language, and various embodiments may thus be implemented using a variety of programming languages.

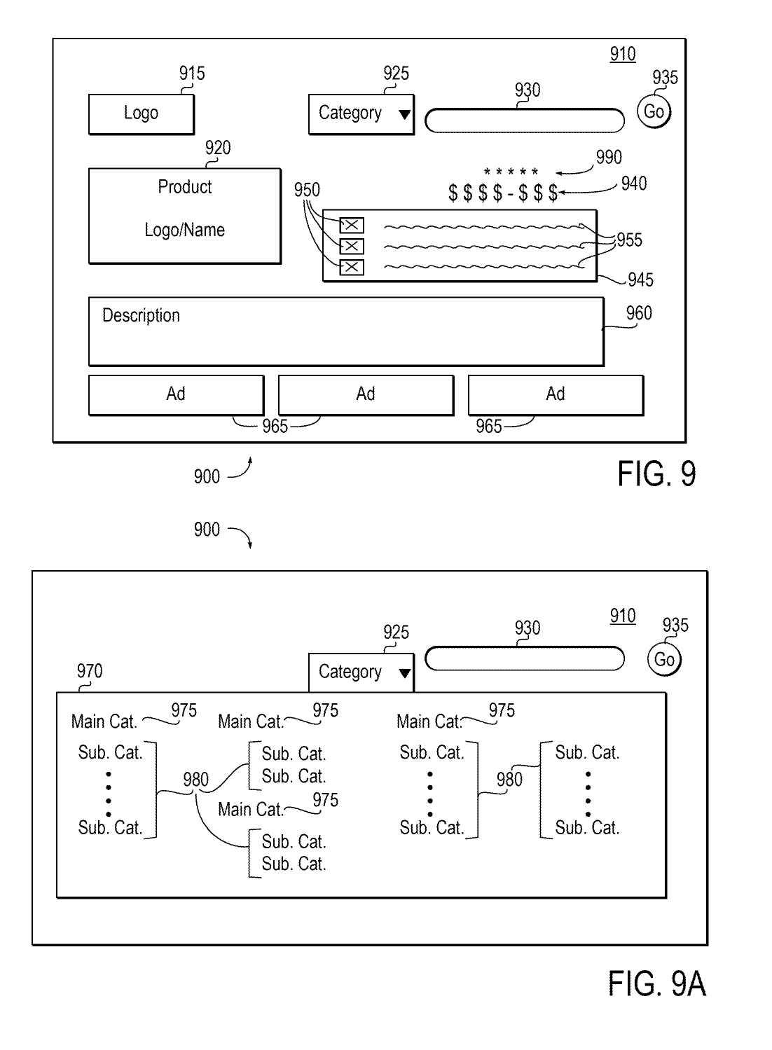

One additional area of illustration concerns user interfaces utilized in communicating with users, both for presenting data to users and for receiving feedback from users. FIG. 9 illustrates an embodiment of a user interface which may be used in presenting data to a user and receiving requests. User interface 900 includes a screen 910 which provides a logo, search interface and display of initial information. Logo 915 provides for identification of the website from a branding perspective. Search interface in this instance includes a category pulldown 925, dialog box 930 and start button 935 (illustrated as a “Go” button here).

Initial information is provided when a user initially visits a website, and provides an opportunity to market to a user on a first impression. A featured product may be illustrated, such as through product logo 920 and description 960. Additionally, icons 950 and features 955 are shown in a box near logo 920, allowing for callouts of additional aspects of the featured product. Moreover, based on information in the ratings database, a price range 940 and a rating 990 are provided. Thus, a featured product may be presented with a variety of different information which may lead to impulse purchases. Also, advertisements 965 are presented, in this case in the form of banner advertisements along the bottom of the screen 910. Such advertisements may be rotated, may be related to the featured product, or may be related to an identified user of the user interface 900.

One option from interface 910 is to display categories of products. FIG. 9A illustrates an embodiment of the user interface of FIG. 9 displaying categories for selection. Category menu 970 drops down from category dropdown 925 upon receipt of selection of dropdown 925 by a user. Category dropdown menu 970 includes main categories 975 and sub-categories 980. Sub-categories 980 may come in various different numbers for a given main category, and both main categories 975 and sub-categories 980 may dynamically shift over time, in response to changes in data gathered in a ratings database, or in response to changes implemented across a system, for example. One may select a category to choose to browse goods or services in a category grouping similar types of goods or services.

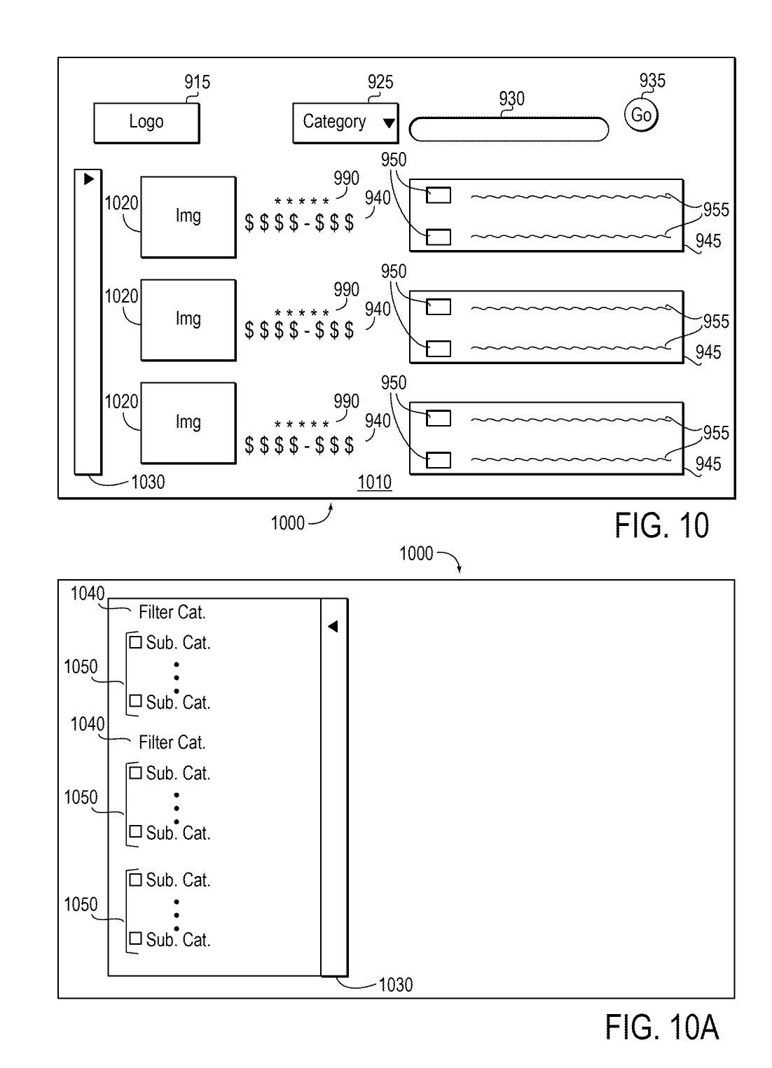

FIG. 10 illustrates an embodiment of a user interface which may be used to present data about a set of products to a user. A set of products may be a group of goods or services having identified common features (e.g. a category). A set of products may also be products provided in response to a query—thus a set of products which satisfy a query, and likely have some similar features. User interface 1000, particularly screen 1010, presents a logo 915 and search interface (category dropdown 925, dialog box 930 and start button 935). Also presented is a set of products, presented as an image 1020, rating 990, price range 940, icons 950 and features 955. In this instance, three products are presented. Also available is a collapsed menu bar 1030.

FIG. 10A illustrates an embodiment of the user interface of FIG. 10 which displays categories for selection. The categories displayed relate to filtering results of a query, and are provided through menu bar 1030. Filter selection menu 1035 provides for filter categories 1040 and filter subcategories 1050. Collectively, these categories 1040 and subcategories 1050 allow for selection of subgroups of products, based on common characteristics of various types of products. Such categories and subcategories may be manually selected or may be extracted through automated analysis of data such as ratings data, review data and description data for products. One may expect that selection of various filter options will result in a redisplay of the information of FIG. 10, or possibly is display of a single product fitting the desired criteria.

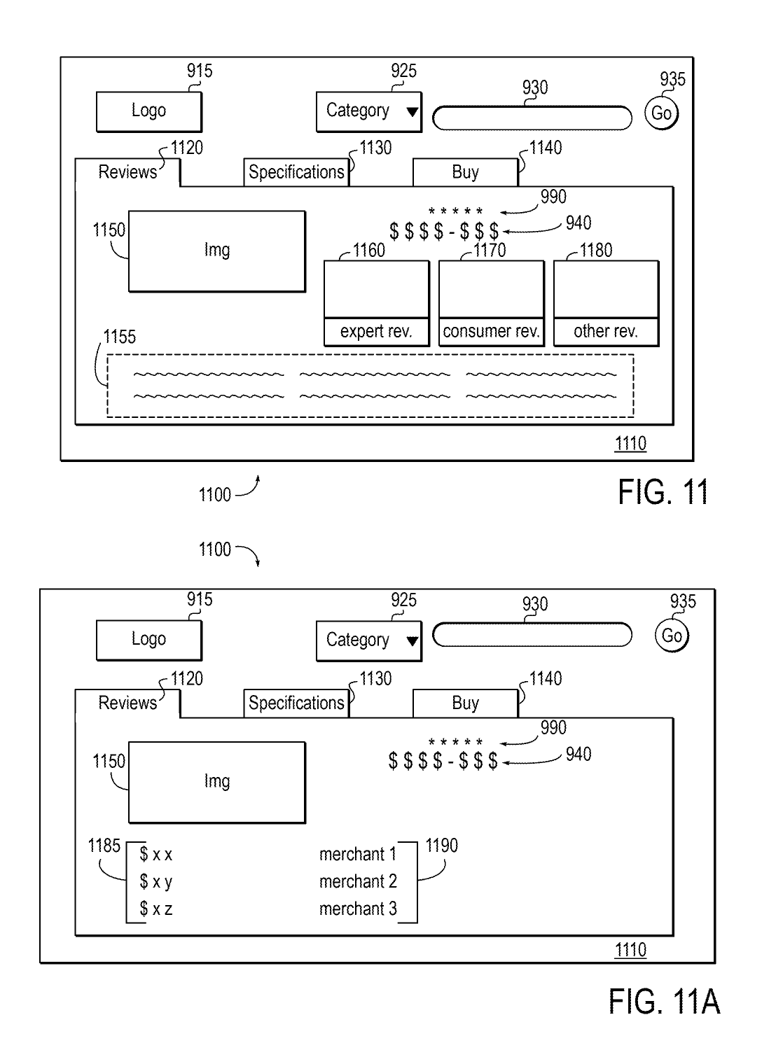

When a single product is selected by a user, whether a featured product, a product displayed in response to a query, or a single product resulting from various filters, information about that single product may be displayed to facilitate a transaction for that product. FIG. 11 illustrates an embodiment of a user interface which may be used to present review and recommendation data about a specific product to a user. Interface 1100, including screen 1110 provides the category dropdown 925, search dialog box 930 and start button 935, along with a site logo 915. Also provided are review tab (or button) 1120, specifications tab 1130 and by tab 1140. Shown in FIG. 11 is the display associated with review tab 1120. A product image 1150 and product description 1155 provide information about the product, along with a price range 940 and rating 990. Buttons 1160, 1170 and 1180 allow for selection of specific types of reviews and ratings, namely expert, consumer and other reviews, respectively. Selection of any of these buttons limits review and ratings data to the selected type of information, and results in recalculation of price range 940 and review 990 for the selected subset of reviews.

Should someone wish to review specifications of a product, specifications tab 1130 may be selected to display specification data. Additionally, should someone wish to purchase a product, selection of buy tab 1140 may allow for this. FIG. 11A illustrates an embodiment of the user interface of FIG. 11, which may be used to present information about buying a product to a user. Image 1150 remains in the display, along with price range 940 and rating 990. Prices 1185 and corresponding merchants 1190 are provided, allowing a user to see a range of potential sellers and associated prices. Merchant names 1190 may include links to associated websites for such merchants 1190, allowing for a user to initiate a purchase. Note that such links may go to a general landing page of a website, or to a specific page for the product in question, for example.

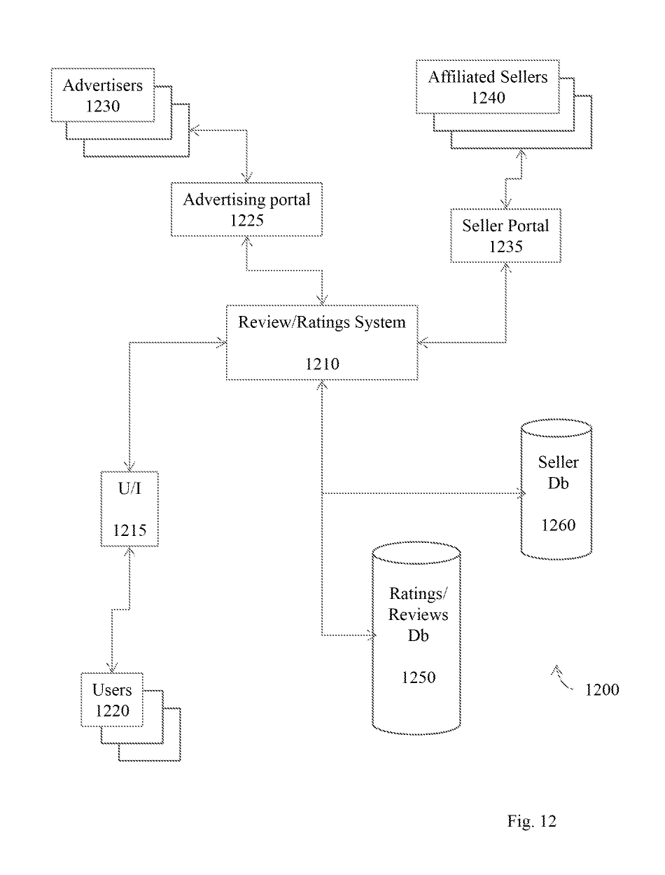

Sellers, advertisers and other participants in the ecosystem leading to ratings, reviews and sales of products may seek to interact in a number of ways. FIG. 12 illustrates an embodiment of a system such as the system of FIG. 6 which incorporates access for advertising and selling. System 1200 includes the review and ratings system 1210, an advertising portal 1225, a sales portal 1235, a review database 1250 and a seller database 1260, along with a user interface 1215. Users 1220 may be expected to interact with user interface 1215, as described throughout this document.

Advertisers 1230 may be expected to submit advertising through advertising portal 1225. Note that advertising portal 1225 may incorporate a user interface for human interaction and an API for system level interaction with other advertising systems, for example. Similarly, sellers may be affiliated sellers 1240, interacting with a portal 1235 to submit pricing information and preferred landing pages, for example, and building up a seller database 1260. However, a seller database 1260 may also be compiled from a crawler similar to that used in earlier figures, for example, finding data on networks about selling prices, etc. All of this may be used to provide the user interface 1215 to users 1220, such as through the user interfaces described with respect to FIGS. 9, 9A, 10, 10A, 11 and 11A, for example.

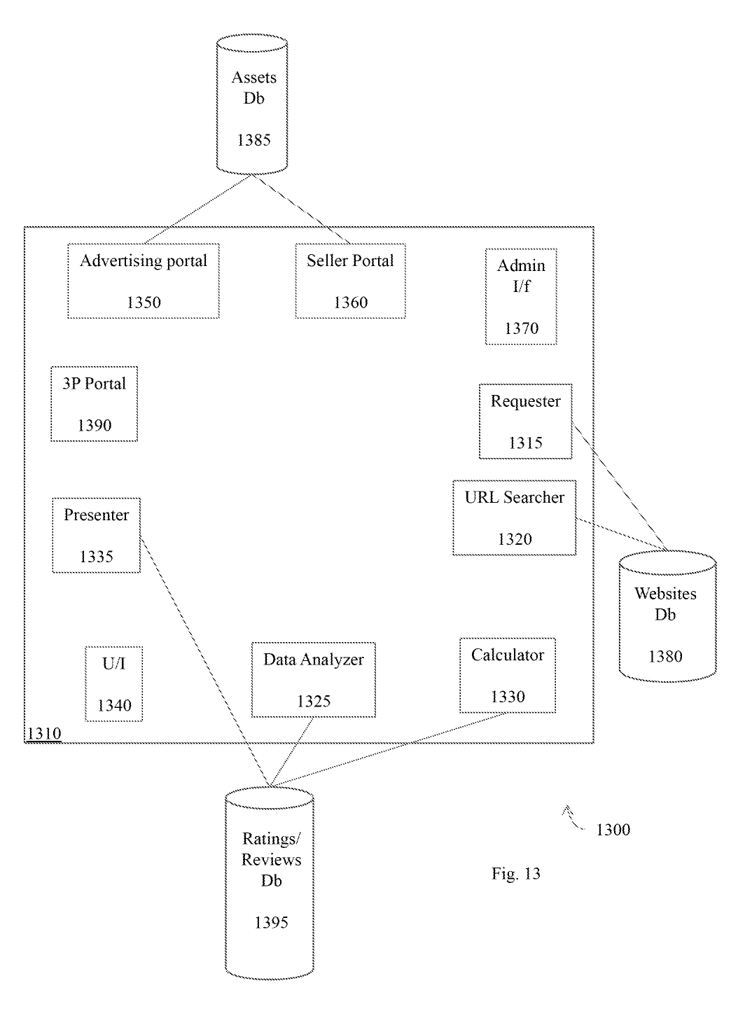

FIG. 13 illustrates an alternative embodiment of the system of FIG. 12. System 1300 may be implemented in a similar manner to system 1200 of FIG. 12, and may provide the same features in some embodiments. System 1300 uses medium 1310, which may be singular or multiple in nature, and integrated or distributed as well. System 1300 includes a user interface 1340 which interacts with users, such as along the lines of the user interface of FIGS. 9, 9A, 10, 10A, 11 and 11A, for example. Presenter 1335, data analyzer 1325 and calculator 1330 interact with a reviews database 1375 (and potentially with user interface 1340) to analyze and normalize review data, and then to present that data to users. Requester 1315 and URL searcher 1320 interact with a website database 1380 to search websites for reviews and to request associated data, thereby populating reviews database 1375.

Advertising portal 1350 and seller portal 1360 interact with assets database 1385 to maintain assets for advertising and for display of products, and receive information from advertisers and sellers. Administrator interface 1370 allows for administrative access to and control of the system 1300. Additionally, third party portal 1390 interacts with third party websites seeking access to system 1300 and its associated data.

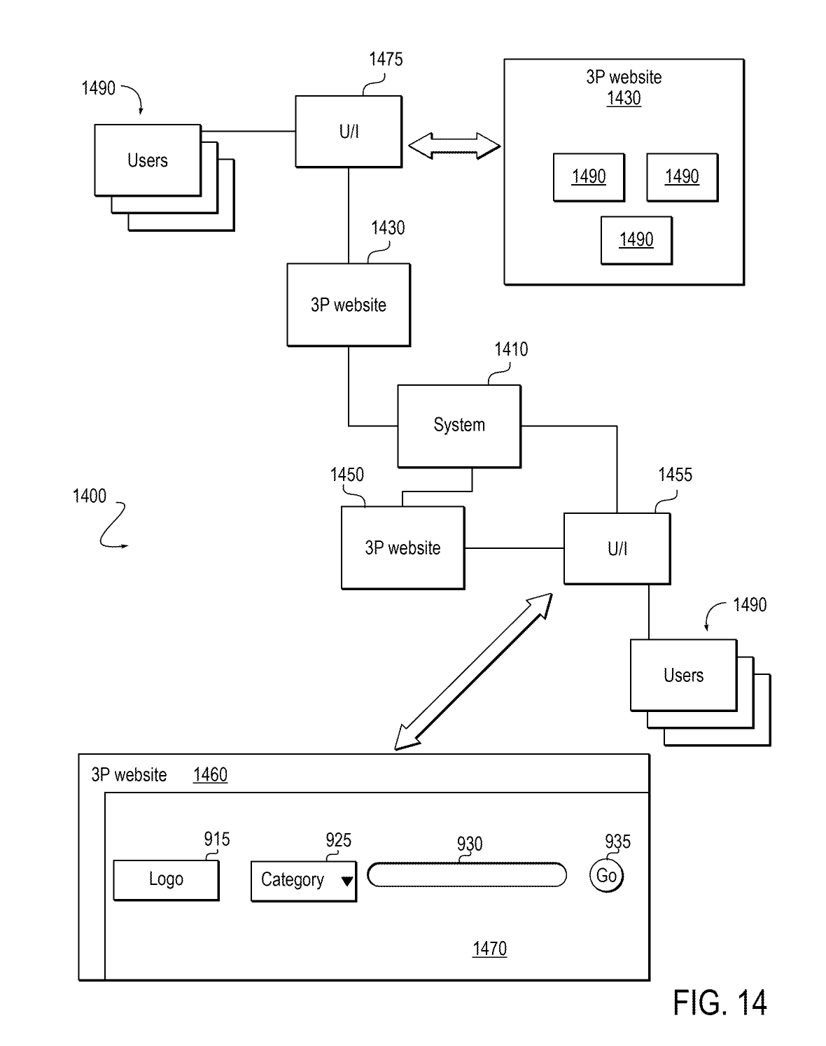

FIG. 14 illustrates an embodiment of the system of FIG. 12 which may be used to provide review and ratings information on third party websites. Third parties can use the system in multiple ways, depending on preferences and payments made. System 1400 includes a review and ratings system 1410, a third party website 1420 which provides data from system 1410 to users, and a third party website 1450, which provides a view of system 1400 through its website.

Third party website 1420 accesses system 1410, sending queries from users 1490 as received through user interface 1425. Data from system 1410 is provided to third party website 1420, which then presents that data as part of a user interface 1430, with data from system 1410 integrated in the interface 1430 as data 1440. Thus, a user 1490 may or may not know that the data in question comes from system 1410, but gets the benefit of such data, while system 1410 may collect licensing fees for such access.

In contrast, third party website 1450 uses user interface 1455 to interact with other users 1490. User interface 1455 accesses system 1410 and presents data from system 1410 within a user interface 1460, with the presentation format of system 1410. Thus, user interface 1455 essentially provides an alternate access point for the information available through system 1410. In particular, such information is presented as user interface 1470, within the user interface 1460, and includes such elements as the logo 915, category dropdown 925, search dialog box 930 and start button 935.

Note that the system may be expected to generate revenue in a variety of ways. For example, advertising placed on the system may generate revenue through advertising networks and various models. Additionally, referrals of buyers to sellers may generate revenue, such as when a user selects a seller from a list of sellers for a particular item. Moreover, referral of users to websites, either review websites or sales websites, may result in similar types of revenue. Also, licensing of content for use in websites may generate revenue, either through use of the content in a third-party website, or through provision of the user interface and content of the system in the third-party website.

One skilled in the art will appreciate that although specific examples and embodiments of the system and methods have been described for purposes of illustration, various modifications can be made without deviating from present invention. For example, embodiments of the present invention may be applied to many different types of products and services, and may be organized in a variety of different ways. Moreover, features of one embodiment may be incorporated into other embodiments, even where those features are not described together in a single embodiment within the present document.

1. A method of aggregating website information on a computer, comprising:
accessing a next website in a database of websites of the computer;
receiving data from the next website at the computer;
storing data from the next website in a ratings database of the computer;
extracting links to other websites from the data from the next website;
storing the links to other websites in the database of websites;
advancing the next website of the database of websites within the database of websites to the website after the website just accessed;
and
repeating the accessing, receiving, storing data, extracting, storing the links and advancing.

2. The method of claim 1, further comprising:
accessing a dataset in a ratings database of the computer;
determining if the dataset in the ratings database includes data retrieved after the dataset was last accessed on the computer;
extracting ratings data from the dataset;
normalizing ratings data of the dataset;
storing the ratings data of the dataset with normalized ratings within the ratings database;
extracting review data from the dataset;
normalizing review data of the dataset;
storing the review data of the dataset with normalized reviews within the ratings database;
identifying a dataset sequentially following the dataset just accessed;
advancing to the dataset following the dataset just accessed;
and
repeating the accessing, determining, extracting ratings data, normalizing ratings data, storing the ratings data, extracting review data, normalizing review data, storing the review data, identifying the dataset and advancing to the dataset.

3. The method of claim 2, further comprising:
receiving a user query from a user, the user query including keywords;
querying a ratings database of the computer responsive to the user query, using the keywords of the user query;
receiving responsive data from the ratings database responsive to the querying;
organizing responsive data from the ratings database based on preferences of the user;
presenting the responsive data from the ratings database to the user through a user interface;
receiving customization requests from the user;
filtering the responsive data from the ratings database responsive to the customization requests from the user;
and
presenting the responsive data from the ratings database as filtered to the user through the user interface.

4. The method of claim 2, further comprising:
receiving a user query from a user, the user query including keywords;
querying a ratings database of the computer responsive to the user query, using the keywords of the user query;
receiving responsive data from the ratings database responsive to the querying;
organizing responsive data from the ratings database based on preferences of the user;
and
presenting the responsive data from the ratings database to the user through a user interface.

5. The method of claim 4, further comprising:
receiving customization requests from the user;
filtering the responsive data from the ratings database responsive to the customization requests from the user;
and
presenting the responsive data from the ratings database as filtered to the user through the user interface.

6. The method of claim 1, further comprising:
accessing a dataset in a ratings database of the computer;
determining if the dataset in the ratings database includes data retrieved after the dataset was last accessed for normalizing ratings data on the computer;
extracting ratings data from the dataset;
normalizing ratings data of the dataset;
and
storing the ratings data of the dataset with normalized ratings within the ratings database.

7. The method of claim 6, further comprising:
accessing a dataset in a ratings database of the computer;
determining if the dataset in the ratings database includes data retrieved after the dataset was last accessed for normalizing review data on the computer;
extracting review data from the dataset;
normalizing review data of the dataset;
and
storing the review data of the dataset with normalized reviews within the ratings database.

8. The method of claim 1, further comprising:
receiving a user query from a user, the user query including keywords;
querying a ratings database of the computer responsive to the user query, using the keywords of the user query;
receiving responsive data from the ratings database responsive to the querying;
organizing responsive data from the ratings database based on preferences of the user;
presenting the responsive data from the ratings database to the user through a user interface;
receiving customization requests from the user;
filtering the responsive data from the ratings database responsive to the customization requests from the user;
and
presenting the responsive data from the ratings database as filtered to the user through the user interface.

9. A method of adjusting website information on a computer, comprising:
accessing a dataset in a ratings database of the computer;
determining if the dataset in the ratings database includes data retrieved after the dataset was last accessed on the computer;
extracting ratings data from the dataset;
normalizing ratings data of the dataset;
storing the ratings data of the dataset with normalized ratings within the ratings database;
extracting review data from the dataset;
normalizing review data of the dataset;
storing the review data of the dataset with normalized reviews within the ratings database;
identifying a dataset sequentially following the dataset just accessed;
advancing to the dataset following the dataset just accessed;
and
repeating the accessing, determining, extracting ratings data, normalizing ratings data, storing the ratings data, extracting review data, normalizing review data, storing the review data, identifying the dataset and advancing to the dataset.

10. The method of claim 9, further comprising:
accessing a next website in a database of websites of the computer;
receiving data from the next website at the computer;
storing data from the next website in a ratings database of the computer;
extracting links to other websites from the data from the next website;
storing the links to other websites in the database of websites;
advancing the next website of the database of websites within the database of websites to the website after the website just accessed;
and
repeating the accessing, receiving, storing data, extracting, storing the links and advancing.

11. The method of claim 10, further comprising:
receiving a user query from a user, the user query including keywords;
querying a ratings database of the computer responsive to the user query, using the keywords of the user query;
receiving responsive data from the ratings database responsive to the querying;
organizing responsive data from the ratings database based on preferences of the user;
presenting the responsive data from the ratings database to the user through a user interface;
receiving customization requests from the user;
filtering the responsive data from the ratings database responsive to the customization requests from the user;
and
presenting the responsive data from the ratings database as filtered to the user through the user interface.

12. The method of claim 9, further comprising:
accessing a dataset in a ratings database of the computer;
determining if the dataset in the ratings database includes data retrieved after the dataset was last accessed for normalizing ratings data on the computer;
extracting ratings data from the dataset;
normalizing ratings data of the dataset;
and
storing the ratings data of the dataset with normalized ratings within the ratings database.

13. The method of claim 9, further comprising:
accessing a dataset in a ratings database of the computer;
determining if the dataset in the ratings database includes data retrieved after the dataset was last accessed for normalizing review data on the computer;
extracting review data from the dataset;
normalizing review data of the dataset;
and
storing the review data of the dataset with normalized reviews within the ratings database.

14. The method of claim 9, further comprising:
receiving a user query from a user, the user query including keywords;
querying a ratings database of the computer responsive to the user query, using the keywords of the user query;
receiving responsive data from the ratings database responsive to the querying;
organizing responsive data from the ratings database based on preferences of the user;
and
presenting the responsive data from the ratings database to the user through a user interface.

15. The method of claim 14, further comprising:
receiving customization requests from the user;
filtering the responsive data from the ratings database responsive to the customization requests from the user;
and
presenting the responsive data from the ratings database as filtered to the user through the user interface.

16. A method of accessing website information on a computer, comprising:
receiving a user query from a user, the user query including keywords;
querying a ratings database of the computer responsive to the user query, using the keywords of the user query;
receiving responsive data from the ratings database responsive to the querying;
organizing responsive data from the ratings database based on preferences of the user;
presenting the responsive data from the ratings database to the user through a user interface;
receiving customization requests from the user;
filtering the responsive data from the ratings database responsive to the customization requests from the user;
and
presenting the responsive data from the ratings database as filtered to the user through the user interface.

17. The method of claim 16, further comprising:
accessing a next website in a database of websites;
receiving data from the next website;
storing data from the next website in a ratings database;
extracting links to other websites from the data from the next website;
storing the links to other websites in the database of websites;
advancing the next website of the database of websites within the database of websites to the website after the website just accessed;
accessing a dataset in a ratings database;
determining if the dataset in the ratings database includes data retrieved after the dataset was last accessed;
extracting ratings data from the dataset;
normalizing ratings data of the dataset;
storing the ratings data of the dataset with normalized ratings within the ratings database;
extracting review data from the dataset;
normalizing review data of the dataset;
storing the review data of the dataset with normalized reviews within the ratings database;
identifying a dataset following the dataset just accessed;
and
advancing to the dataset following the dataset just accessed.

18. The method of claim 16, further comprising:
accessing a dataset in a ratings database of the computer;
determining if the dataset in the ratings database includes data retrieved after the dataset was last accessed for normalizing ratings data on the computer;
extracting ratings data from the dataset;
normalizing ratings data of the dataset;
and
storing the ratings data of the dataset with normalized ratings within the ratings database.

19. The method of claim 16, further comprising:
accessing a dataset in a ratings database of the computer;
determining if the dataset in the ratings database includes data retrieved after the dataset was last accessed for normalizing review data on the computer;
extracting review data from the dataset;
normalizing review data of the dataset;
and
storing the review data of the dataset with normalized reviews within the ratings database.

20-23. (canceled)
